(19) United States
(12) Patent Application Publication
(10) Pub. No.: US 2016/0341233 A1
(43) Pub. Date: Nov. 24, 2016

(54) Folding anchor

(71) Applicant: Eitan Sobel, Rutland, VT (US)

(72) Inventor: Eitan Sobel, Rutland, VT (US)

(21) Appl. No.: 14/715,374

(22) Filed: May 18, 2015

(51) Int. Cl. F16B 13/08

(52) U.S. Cl. CPC F16B 13/0808; F16B 2013/105

(57) ABSTRACT

A folding anchor made of at least two members consecutively inserted into an insertion hole of a panel. As leading members of the folding anchor enter the space behind the panel, they are predeterminedly repositioned relatively to their trailing members. The last member is mounted into the insertion hole. A member of the folding anchor that is not the last member comprises a fastening receiver. A fastening rod is fastened into the fastening receiver and generates pulling forces. Those pulling forces are transmitted and distributed via a stack of members of the folding anchor to a portion of the back surface of the panel, which counteracts those pulling forces.

### FIELD OF THE INVENTION

The present invention relates to the field of anchors used to fasten an object to a surface of a panel.

### BACKGROUND

Anchors are attached to panels by different designs and methods. Typically, anchors are consisted of a fastening receiver such as a nut attached to an anchor body. A fastening rod such as a screw or a bolt is fastened into the fastening receiver and forces applied on the fastening receiver are transmitted and distributed by the anchor body to a contact area of the panel. Counter forces generated by the panel counteract the forces transmitted to the panel. Most anchors are inserted through an insertion hole made in the panel. Some anchors are attached to the hole itself as they expend inside while other anchors use the back surface of the panel to counteract forces apply on them.

Expending anchors are most useful in solid materials like wood, concrete, brick, mortar or metals. Expending anchors expand when fastening rods are inserted or threaded into the fastening receivers and produce high shear forces that prevent the anchors from dislodging. Therefore, the strength of the expending anchors depends on the strength of the material of the panel.

Back-surface anchors are designed to be used in thin panels or in hollow walls. Back-surface anchors are inserted through an insertion hole in a panel and they are designed to open-up or spread behind the panel in a way that they cannot be pulled back through the insertion hole. The strength of a Back-surface anchors is proportional to the size of the back-surface contact area and more specifically, the length of the circumference of that area. Back-surface anchors could theoretically provide amazing resistances despite a relatively weak material of the panel.

It is extremely important to match the right anchor with the material of the panel, the expected forces applied on the anchor and the direction of the forces. An anchor that is mismatched with the expected load, usage and the material of the panel will eventually loosen up and damage the panel.

The most commonly used expanding anchors are the push-in plastic expansion anchors (for example, U.S. Pat. No. 1,878,600). They are available in many sizes and designs. When a screw is threaded into a plastic anchor it expands, exerting forces against the walls of the hole. Better expansion anchors are made of lead and metal. The stronger the panel material, the stronger the resistance provided by the expansion anchor. Push-in plastic expansion anchors may provide pulling resistance of around 30 pounds in concrete but less than 10 lbs in drywall. Generally speaking, plastic anchors hold well vertical forces such as hanging a picture frame but may be too weak for pulling forces that are perpendicular to the panel plan.

Threaded drywall Anchors (for example, U.S. Pat. 8,192,123 B2), represent an improvement over the push-in plastic expansion anchors. Those anchors are threaded into the dry wall by a Philip's head fastening driver. Threaded drywall anchors are available in both nylon and metal and provide a better pulling resistance of about 15 lbs to 25 lbs in dry wall. Although threaded Drywall Anchors are stronger than push-in plastic anchors, they still should be used primarily for vertical forces and should not be used for significant pulling forces.

A commonly used back-surface anchors are the winged plastic Anchors (for example, U.S. Pat. No. 4,993,901). This winged plastic anchors double the pulling resistance of a push-in plastic expansion anchors to about support from 25 to 35 lbs in drywall. As a fastening rod is inserted into a winged plastic anchors, the wings of the anchor are pushed out against the back of the panel. Tightening the fastening rods too much may cause damage to the threads resulting in a weaker anchor.

Sleeve-type anchors have a better opening or spreading mechanism as they are combine a screw, a sleeve and a compression mechanism (for example, U.S. Pat. No. 2,918,841, U.S. Pat. No. 3,143,915 and U.S. Pat. No. 4,720,224). The sleeve-type anchors are easily pushed into a hole and as the fastening rod tightens the sleeve folds outwards and creates ‘teeth’ that hold the anchor against the backside of the panel. In hollow dry walls, sleeve-type Anchors can hold up to 50 lbs. In solid materials like a concrete wall, the sleeve-type anchors are actually very useful and provide good resistance to pull forces.

The toggled anchors are back-surface anchors. The toggled anchors may either use hinged wings or a bar that distribute forces applied on the fastening receiver. Hinged wings type toggled anchor (for example, U.S. Pat. No. 3,389,631) looks like a pair of spring-loaded metal wings attached to a central fastening receiver having a long fastening rod. When the toggled anchor is inserted through the hole, the wings are folded toward the central fastening rod. Once the wings pass the thickness of the panel, they open up and press against the back surface of the panel as the fastening rod tightens. The strength of a traditional Wings type toggled anchor is about 30 lbs for a ⅛″ toggled anchor and 50 lbs for a ⅜″ toggled anchor. Bar type toggled anchors (for example, U.S. Pat. No. 549,069, U.S. Pat. No. 1,003,527, U.S. Pat. No. 1,061,480, U.S. Pat. No. 1,159,420 and many more) provide a larger contact area with the back surface of the panel. The size of the contact area is very important in preventing damages to the material of the panel.

A SnapToggle anchors have several advantages over other types of bar type toggle anchors. (For example, US Patent Application 2011\0268528). The SnapToggle anchor is easy to insert and maneuver and it contains a plastic cap that slides over two plastic straps and locks the anchor in the insertion hole. The SnapToggle anchor is using a U shape bars that provide pull force up to 265 lbs in ½″ drywall. The advantage of a U shape bars is the long contacts circumference lines with the back surface of the panel and hence a better pulling resistance, however the disadvantage of a U shape bar is the very small contact area, which increases the risk of damages to the dry wall and overtime it may resulted in loosening of the anchor. A similar idea to the SnapToggle anchor is shown in another US patent (US Patent Application 2014\0102040). The anchor is actually based on a flat metal bar inserted through the insertion hole into to the space behind the panel. The metal bar is pulled by a cord that substitutes the role of the cap and the straps.

There are certainly many more patents, patents applications and different designs that represent combinations, variations, modifications, improvements, enhancements and different uses of the basic anchors discussed above. Some of them provide real additional advantages while other may have no added value or may even be inferior to the anchors presented above. In summary, a good anchor design must be simple, ‘fool proof’, inserted through a small hole as possible, have a larger contact area on the back surface of the panel and have a smaller risk of future loosening of the anchor and/or damages to the panel. Therefore, despite numerous solutions and designs of anchors, there is still a need for better and simpler anchor, which is the objective of the current invention.

### SUMMARY OF THE INVENTION

The available anchors are products of our symmetrical thinking. The insertion hole creates an imaginary axis perpendicularly to the plane of the panel. Because of our symmetrical thinking, we rotate parts of the anchor away from the imaginary axis to hold the anchor in place. However, a non-symmetrical approach opens a door to a host of new anchors designs and creates numerous possibilities and combinations of anchors that offer significant improvements over the current art

The folding non-symmetrical anchor is built from at least two consecutive members inserted through an insertion hole of the panel from the first member to the last member. Each two consecutive members are coupled by means for repositioning one member relatively to the other. Initially, those two consecutive members are positioned away from each other for the insertion through the insertion hole, but as the leading member of the two consecutive members passes the thickness of the panel and enters the space behind the panel, it repositions towards its trailing member. This process folds the anchor behind the panel. The last member is mounted into the insertion hole and thereby it controls the final position of each member of the anchor behind the panel. A member that is not the last member comprises a fastening receiver such as a nut. A fastening rod such as a screw or a bolt is inserted through the insertion hole is fastened into the fastening receiver. A stack of contiguous members having at least the one member comprises the fastening receiver is contiguous to a portion of the back surface of the panel and transmit and distribute pulling forces applied by the fastening rod on the fastening receiver to the panel. The panel generates counter forces that counteract those pulling forces. A common means for repositioning is a pivoting axis. A pivoting axis couples two consecutive members rotates the leading member relatively to its trailing member. A spring can be used to rotate members to theirs final position but gravity can be used as well. The pivotal axis between two members does not have to be positioned at the very end of the members. The pivotal axis could be positioned at other points along the members as long as the leading member can rotate in the space behind the panel and fulfill its function.

Another means for repositioning is an elastic connector coupling two consecutive members. This type of means for repositioning is especially useful for inexpensive anchors made of materials such as plastic and nylon. Elastic connectors could be used for two-dimensional movements but elastic connectors could be used for complex three-dimension movements. Other means for repositioning include but not limited to combinations of several pivoting axes, sliding mechanisms, ball and socket joint mechanisms and combination of means.

In a simple embodiment, the anchor is built of two members coupled by a pivotal axis. The anchor is inserted in its unfolded form. Once the first member passes the thickness of the panel and reaches the space behind the panel, it rotates against the second member, which is the last member of the anchor. The last member of the anchor comprises means for mounting including a ring that mounts into the insertion hole and a disk that lays against the frontal periphery of the insertion hole, thereby, the second member is controlling the position of the first member behind the panel.

In other embodiments, the anchor is built of three members or more. Each two consecutive members are coupled by means for repositioning such as a pivotal axis. The anchor is inserted in its unfolded form. Once the first member passes the thickness of the panel and reach the space behind the panel, it rotates against the second member of the anchor. Then as the second member passes the thickness of the panel, it also rotates against the third member and so forth. The last member of the anchor has means for mounting in the insertion hole. This last step controls the final position of the members behind the panel.

In yet other embodiments, at least one member of the folding anchors further comprises an additional at least one sub-member and means for repositioning such as a pivotal axis. In one of the embodiments, once the sub-member passes the thickness of the panel and reaches the space behind the panel, the sub-member turns in about 90 degrees to the originating member and creates a cross-like structure that further increases the contact area between the folding anchor and the back surface of the panel.

In additional embodiments, at least one member of the folding anchor further comprises an additional at least one sub-member that is branching away from the member by means for repositioning such as a pivotal axis to further increase the contact area with the back surface of the panel.

In some embodiments, the members do not reposition against each other but rather a side-by-side. Those embodiments allow leading members to reach the back surface of the panel. In one example of those embodiments, the anchor is made of two members. The first member is a metal bar having a pivoting axis on one end and a about centrally located fastening receiver. The second member is coupled at one end to the pivoting axis by a side-by-side configuration to the first member and on the other end of the second member comprises means for mounting including a ring and a disk that mount into the insertion hole. As the metal bar passes the thickness of the panel and reaches the space behind the panel, it rotates until it lay against the back surface of the panel. The fastening receiver of this metal bar is aligned with the insertion hole.

In an economical version of the last embodiments, a simpler and cheaper elastic connector is substituted as means for repositioning. A variety of materials can be used including metal, plastic and/or nylon. The anchor comes in its folded final position. The members of the folded anchor are unfolded and inserted consecutively in a zigzag fashion into the insertion hole and the last member is mounted into the insertion hole.

Yet other embodiments further include means for triggering. Members of the anchor are locked in their unfolded position by the means for triggering. Releasing the locked members to their final positions by the means for triggering is decided and timed by the operators. A pull rod or a sleeve that could be pulled back as the anchor is inserted provides an illustration of this concept. The exposed members of the anchor will then fold to their final position. Embodiments may further combine means for preventing rotation of the fastening receiver and/or any other member that is subjected to shear forces generated by the threading of the fastening rod into the fastening receiver. Means for preventing rotation may further wedge into the back surface of the panel and prevent damage and distortion of the folding anchor. Embodiments may further include means for preventing non-flushed seating of the stack on the back surface of the panel. During drilling of an insertion hole in the panel, some material of the panel can be pushed backwards creating a hump of the back surface of the panel around the insertion hole. This may happen when drilling is done too fast or forcefully. Mon-flushed seating of the stack on the back surface of the panel will result in fastening receiver that is not perfectly perpendicular to the panel resulting in difficulties of fastening the fastening rod into the fastening receiver. Means for preventing non-flush seating provide some space for pushed back panel material around the rim of the insertion hole that does get in the way between the frontal surface of the stack and the back surface of the panel.

The current disclosure is also a novel method of inserting an anchor into a panel. The first step of the method is creating an insertion hole in said panel in a predetermined size and location for the insertion of the folding anchor. The next step is insertion of the members of the folding anchor consecutively from a first member to a last member. Each subsequent member of the folding anchor pushes each leading member into a space behind the panel where the leading members fold into their final position. The next step is mounting the last member into the insertion hole and essentially establishing the final position of all the members of the folding anchor. The next step is insertion of a fastening rod that is fastened into a fastening receiver of the folding anchor. The fastening rod transmits pulling forces to said fastening receiver and from there, the pulling forces are transmitted and distributed via a stuck of at least one member a portion of the back surface of the panel. The panel generates counter forces that counteract the pulling forces

The different embodiments and methods disclosed in this application are just some examples to the host of implementations and combinations possible with the novel concept of the folding anchor. Some features, options, and advantages may be shown in certain embodiments but may not be shown in other. And yet, any part of the subject matter of the present invention may be combined in any suitable manner in one or more embodiments, designs and/or implementations. Any part of the present disclosure may be also incorporated into existing anchors. Furthermore, designs, structures, materials, features or operations may not shown or described in detail to avoid obscuring aspects of the subject matter of the present disclosure. The current disclosure describes the principals, concepts, details, designs, features, methods, structures, characteristics and/or advantages of the novel anchor so that anyone skilled in the art can understand and implement either all or any part of the subject matter. The features and advantages of the subject matter of the present disclosure will become more fully apparent from the following description and appended claims, or may be learned by the practice of the subject matter as set forth hereinafter.

### BRIEF DESCRIPTION OF THE DRAWINGS

FIG. 1, A multi members anchor of four members coupled by three pivotal Axes in an unfolded position.

FIG. 2, The anchor of FIG. 1 wherein the first and the second members passed the thickness of the panel and reached the space behind the panel, showing that the first member already rotated about 180 degrees and the second member still having about 90 degrees to rotate to its final position.

FIG. 3, The anchor of FIG. 1 in its final folded position

FIG. 4, A two members anchor. The first member has two levels to ensure even contact of the first and second members with the back surface of the panel.

FIG. 5, The anchor of FIG. 4 wherein the first member passed the thickness of the panel and reached the space behind the panel, showing that the first member have rotated by about 150 degrees.

FIG. 6, The anchor of FIG. 4 in its final folded position

FIG. 7, A three members and one sub-member anchor. The two sub-member is connected by a pivotal axis in an unfolded position.

FIG. 8, The anchor of FIG. 7 wherein the first member passed the thickness of the panel, reached the space behind the panel and have already rotated about 110 degrees.

FIG. 9, The anchor of FIG. 7 wherein the first and the second members passed the thickness of the panel and reached the space behind the panel. The first member has already rotated about 180 degrees and the sub-member has already rotated by about 90 degrees creating a cross like configuration.

FIG. 10, The anchor of FIG. 7 wherein the first member, the second member and the Sub-member are folding towards the last member.

FIG. 11, The anchor of FIG. 7 in its final folded position.

FIG. 12, A different configuration of the anchor of FIG. 7 wherein sub-members are branching out of the second member of FIG. 7.

FIG. 13, A two members anchor coupled by one pivotal Axis in its unfolded position wherein, the pivoting members do not oppose each other but rather rotate side-by-side allowing an overlap rotation

FIG. 14, The anchor of FIG. 13 wherein the first member has passed the thickness of the panel, has reached the space behind the panel and has already rotated about 135 degrees.

FIG. 15, The anchor of FIG. 13 in its final folded position

FIG. 16, A two members anchor coupled by one pivotal Axis in its unfolded position wherein, the pivoting members do not oppose each other but rather rotating side-by-side allowing an overlap rotation. In this embodiment the pivotal axis is not at the very end of the first member. The pivotal Axis is positioned so that the second member can still push the first member passed the thickness of the panel into the space behind the panel. In addition, the second member is curved and has some elastic properties.

FIG. 17, The anchor of FIG. 16 in its final folded position.

FIG. 18, The anchor of FIG. 17 in its final folded position showing the panel. The elastic curved second member is adding pressure on the first member against the back surface of the panel.

FIG. 19, The anchor of FIG. 1 wherein an illustration of means for triggering in the form of a pull rod is added. The members of the anchor are locked in their unfolded position.

FIG. 20, The anchor of FIG. 1 wherein the pull rod was pulled back and the first member has already folded to its final position and the second member has already rotated by about 135 degrees.

FIG. 21, A three members anchor coupled by two pivotal Axes in its unfolded position wherein, the members do not oppose each other but rather rotating side-by-side allowing an overlap rotation. Furthermore, the fastening receiver part of the first member transmits and distributes forces via the second member to the back surface of the panel.

FIG. 22, The anchor of FIG. 21 wherein the first member has passed the thickness of the panel, has reached the space behind the panel and has already rotated about 120 degrees.

FIG. 23, The anchor of FIG. 21 in its final folded position. The fastening receiver part of the first member transmits and distributes forces via the second member to the back surface of the panel

FIG. 24, A three members anchor coupled by two means for repositioning in the form of elastic connectors.

FIG. 25, The anchor of FIG. 24 wherein the first and the third members are unfolded so that members can be inserted consecutively in a zigzag fashion through the insertion hole. Also shown means for preventing rotation by shear forces created by threading of the fastening rod.

FIG. 26, The anchor of FIG. 24 wherein the first member has passed the thickness of the panel, has reached the space behind the panel and has already folded back toward the second member.

FIG. 27, A three members anchor coupled by two means for repositioning in the form of elastic connectors. The first member and the second member are crossing each other. The third member comprises a ring and a disk to be mounted into the insertion hole.

FIG. 28, The anchor of FIG. 27 wherein the members were unfolded so that members can be inserted consecutively in a zigzag fashion through the insertion hole.

FIG. 29, A two members anchor coupled by means for repositioning in the form of elastic connectors in its folded form. The second member comprises a ring and a disk to be mounted into the insertion hole. Also shown means for preventing non-flushed seating of the stack on the back surface of the panel.

FIG. 30, The anchor of FIG. 29 wherein the members were unfolded so that members can be inserted consecutively in a zigzag fashion through the insertion hole.

### DRAWING REFERRENCE NUMERALS

101—Second member

102—Fastening receiver

103—First pivotal axis

104—First Member

105—Second pivotal axis

106—Third Member

107—Insertion hole mounting ring of forth Member

108—Insertion hole mounting disk of forth Member

109—Conduit

110—Rotational arrow showing the direction of the first member

111—Rotational arrow showing the direction of the second member

112—Means for triggering release of members to reposition in a form of a Pull-Rod

113—Arrow showing the direction of the Pull-Rod

114—Third pivotal axis

115—Arrow showing the direction of the third member

151—First member having different thicknesses and a fastening receiver

152—Pivotal axis

153—Second Member

154—Insertion hole mounting ring

155—Insertion hole mounting disk

156—Fastening receiver

157—Rotational arrow showing the direction of the first member

201—Second member having a fastening receiver

202—Fastening receiver

204—Sub-Member means for repositioning and means for passage of a fastening rod

205—Sub-member

206—First pivotal axis

207—First Member

208—Second pivotal axis

209—Insertion hole mounting ring

210—Insertion hole mounting disk

211—Conduit

212—Rotational arrow showing the direction of the first member

213—Rotational arrow showing the direction of the second member

215—Third member

217—Sub-member

218—Sub-member

219—Rotational arrow showing the direction of sub-member 217

220—Rotational arrow showing the direction of sub-member 218

221—Means for repositioning sub-member 217

222—Means for repositioning sub-member 218

301—First member

302—Pivotal axis

303—Second Member

303—Insertion hole mounting ring

305—Insertion hole mounting disk

306—Rotational arrow showing the direction of member 301

307—Conduit

308—Fastening receiver

401—First member

402—Second member made of two bended wires having some elastic properties

403—Pivotal axis

404—Rotational spring

405—Insertion hole mounting ring

406—Insertion hole mounting disk

407—Fastening receiver

408—Rotational arrow showing the direction of the first member 401

408—Panel

501—Second member

502—Fastening receiver in the form of a nut

503—Pivotal axis

504—Third member

505—Insertion hole mounting ring

506—Insertion hole mounting disk

507—Conduit

508—Pivotal axis

509—first member

510—A passage for the fastening rod

511—Rotational arrow showing the direction of the second member 501

512—Rotational arrow showing the direction of the first member 509

601—Second member

602—A passage for the fastening rod in the Second member 601

603—means for preventing rotation by shear forces created by threading of the fastening rod

605—Elastic connector

606—Elastic connector

608—A fastening receiver of the first member

609—Insertion hole mounting ring of the third member

610—Insertion hole mounting disk of the third member

701—Second member

702—A passage for the fastening rod in the Second member 701

703—Elastic connector

704—First member

705—Fastening receiver

706—Elastic connector

707—Insertion hole mounting ring of the third member

708—Insertion hole mounting disk of the third member

709—A Conduit

801—First member

802—Second member

803—Insertion hole mounting ring of the Second member

804—Insertion hole mounting disk of the Second member

805—Elastic connector

806—Fastening receiver

807—A Conduit

808—Means for preventing non-flushed seating of the stack on the back surface of the panel in the form of a space created around the mounting ring.

### DETAILED DESCRIPTION

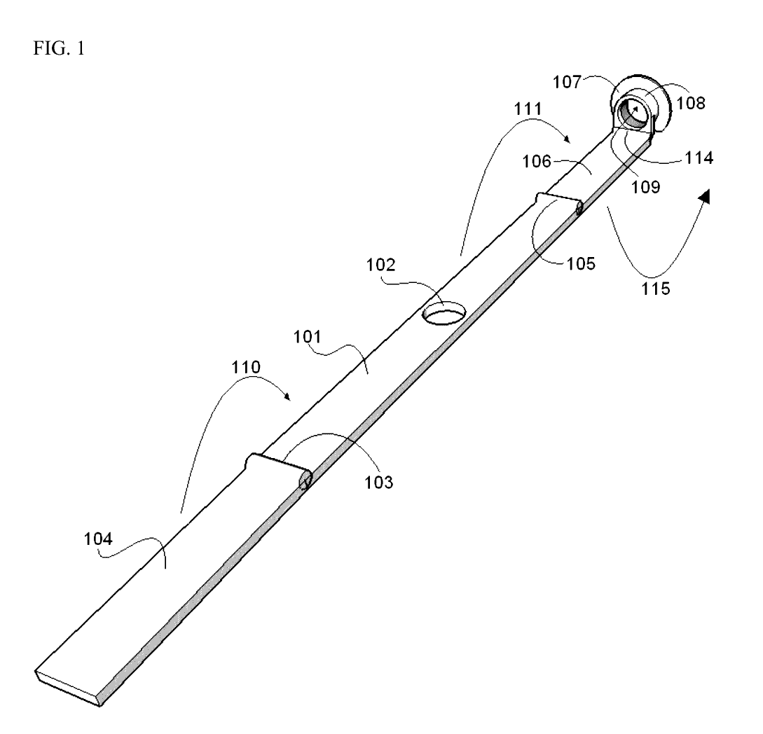

Referring to FIG. 1, the folding anchor is constructed of four members and it is presented in its unfolded position. The first member 104 is coupled to the second member 101 by a pivoting axis 103. The second member 101 is coupled to the third member 106 by a pivoting axis 105. The third member 106 is coupled to the fourth member 107 and 108 by a pivoting axis 114. Means for mounting the last member into the insertion hole are represented by ring 107 and disk 108, but other designs can accomplish the same goal. The first member 104 is inserted first into the insertion hole (not shown). Means for rotating first member 104 in the direction of arrow 110 are represented by pivoting axis 103. After the first member 104 has passed the thickness of the panel and has reached the space behind the panel, it is rotated by pivoting axis 103 in the direction of arrow 110 toward the second member 101. Similarly, after the second member 101 has passed the thickness of the panel and has reached the space behind the panel, it is rotated by pivoting axis 105 in the direction of arrow 111 toward the third member 106. The third member 106 is rotated by pivoting axis 114 in about 90 degrees in an opposite direction, as shown by arrow 115, toward the back surface of the panel.

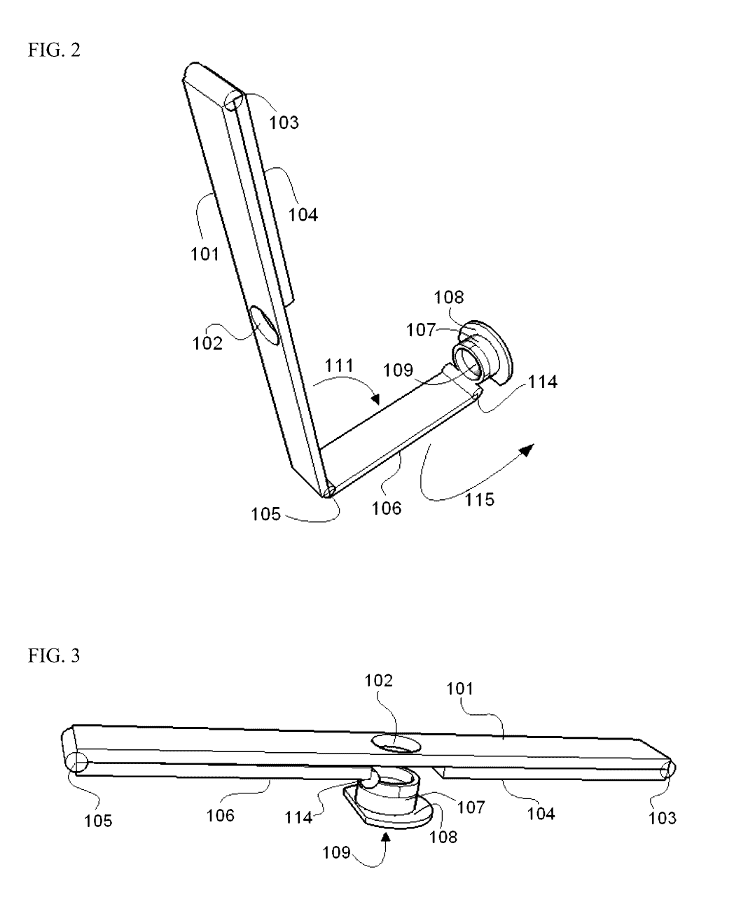

Referring to FIG. 2, the second member 101 of the folding anchor of FIG. 1 has passed the thickness of the panel and has reached the space behind the panel. The first member was already rotated about 180 degrees and the second member 101 is now being rotated by pivoting axis 106 in the direction of arrow 111 toward the third member 106.

Referring to FIG. 3, the folding anchor of FIG. 1 is in its final folded position wherein the conduit 109 is aliened with the fastening receiver 102.

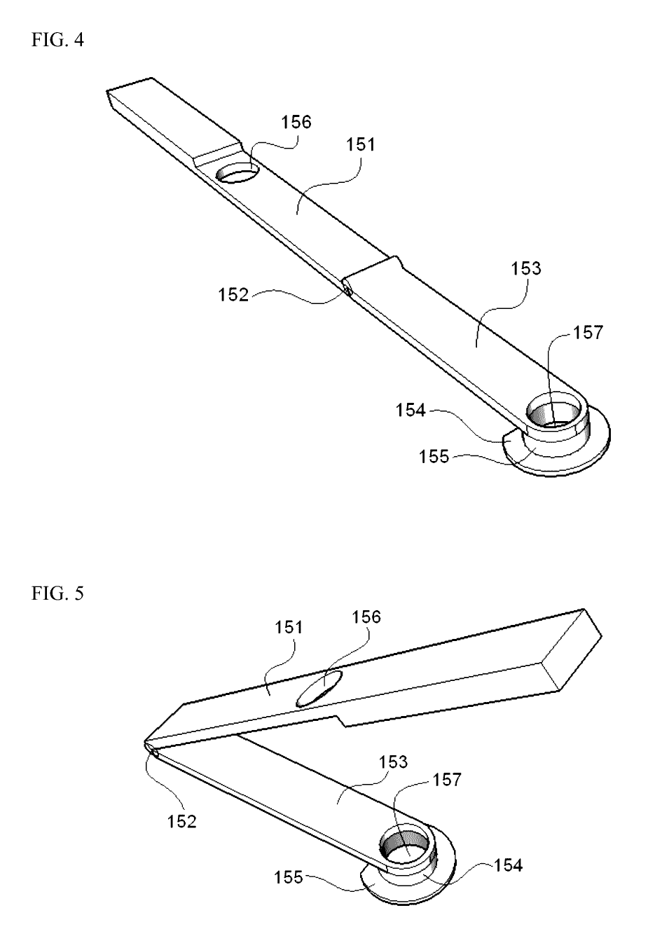

Referring to FIG. 4, a two members anchor presented in its unfolded position. The first member 151 is coupled to the second member 153 by a pivoting axis 152. The first member 151 has two thickness levels so that the final folded anchor lays flat with the back surface of the panel. Means for mounting the last member into the insertion hole are represented by ring 154 and disc 155. The first member 151 is inserted first into the insertion hole (not shown). After the first member 151 has passed the thickness of the panel and has reached the space behind the panel, the first member 151 is rotated by pivoting axis 152 toward the second member 153.

Referring to FIG. 5, the first member 151 of the folding anchor of FIG. 4 has rotated about 150 degrees toward the second member 153.

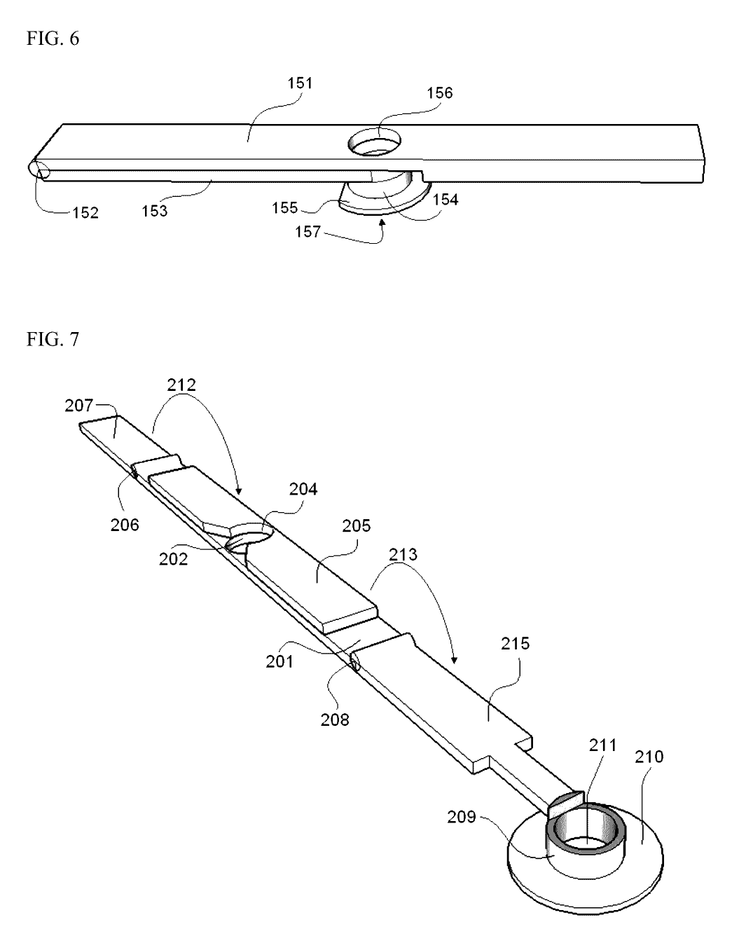

Referring to FIG. 6, the folding anchor of FIG. 4 is in its final folded position wherein the conduit 157 is aliened with the fastening receiver 156.

Referring to FIG. 7, the folding anchor is constructed of three members. The folding anchor is presented in its unfolded position. The first member 207 is coupled to the second member 201 by a pivoting axis 206. The second member 201 is coupled to the third member 215 by a pivoting axis 208. The second member 201 comprises a sub-member 214 and a pivoting axis 204. Means for mounting the last member into the insertion hole are represented by ring 209 and disc 210. The first member 207 is inserted first into the insertion hole (not shown). After the first member 207 has passed the thickness of the panel and has reached the space behind the panel, it is rotated by pivoting axis 206 in the direction of arrow 212 toward the second member 201. After sub-member 205 has passed the thickness of the panel and has reached the space behind the panel, sub-member 205 is rotated by pivoting axis 204 in about 90 degrees, as shown by arrow 214, and becomes about perpendicular to the second member 201. After the second member 201 has passed the thickness of the panel and has reached the space behind the panel, the second member 201 is rotated by pivoting axis 208 in the direction of arrow 213 toward the third member 215.

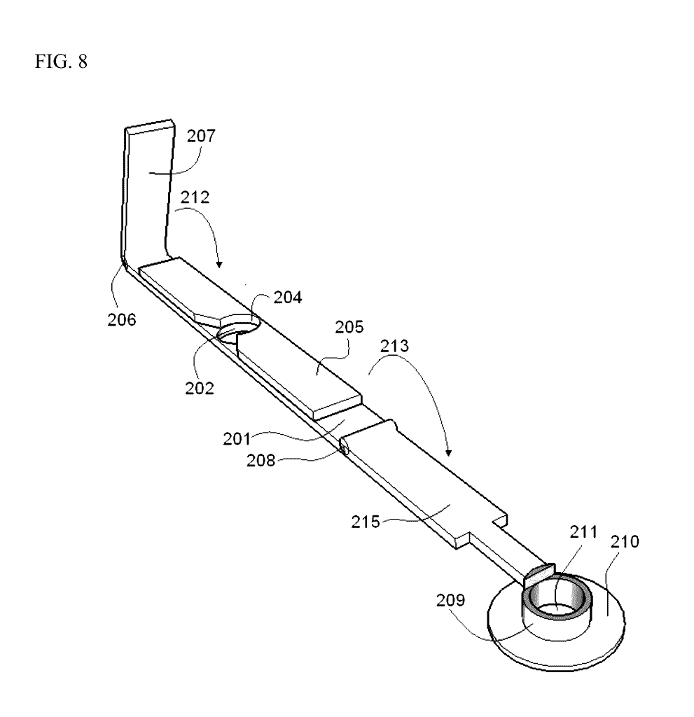

Referring to FIG. 8, the folding anchor of FIG. 7 the first member 207 has passed the thickness of the panel and has reached the space behind the panel, it is being rotated in the direction of arrow 212 toward the second member 201.

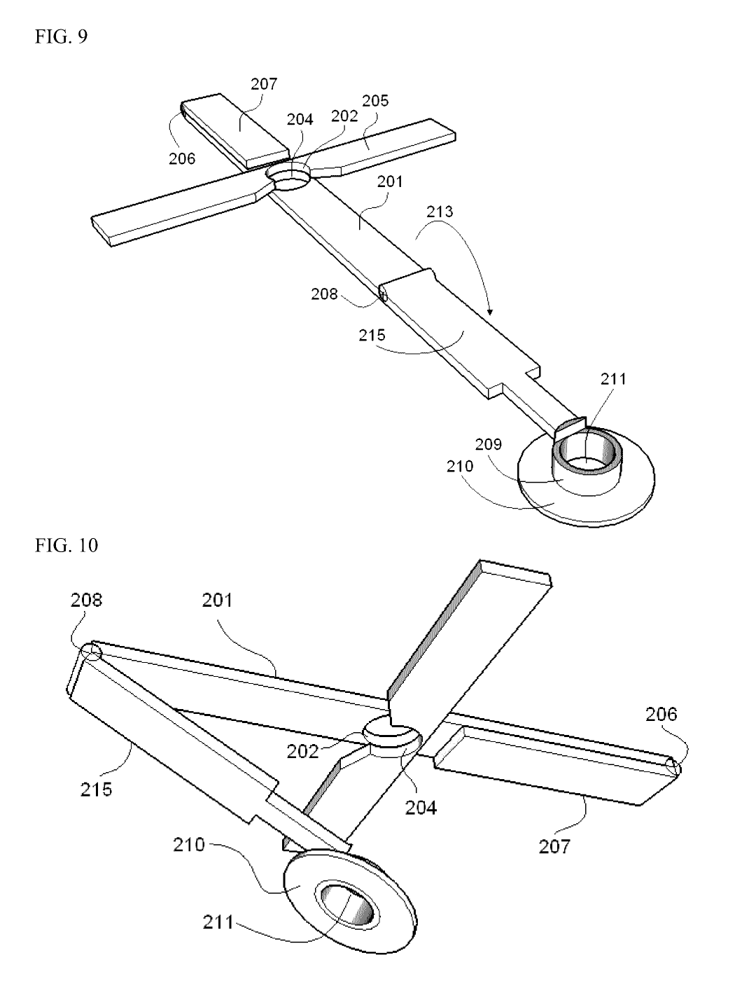

Referring to FIG. 9, the first member 207 of the folding anchor of FIG. 7 has completed its rotation and it is in its final position relatively to the second member 201. The sub-member 205 was rotated by pivoting axis 204 by about 90 degrees and became about perpendicular to the second member 201. The second member 201 had not passed the thickness of the panel and therefore, it was not rotated yet.

Referring to FIG. 10, the folding anchor of FIG. 7 after the second member 201 has passed the thickness of the panel and has reached the space behind the panel, it is being rotated towards the third member 215.

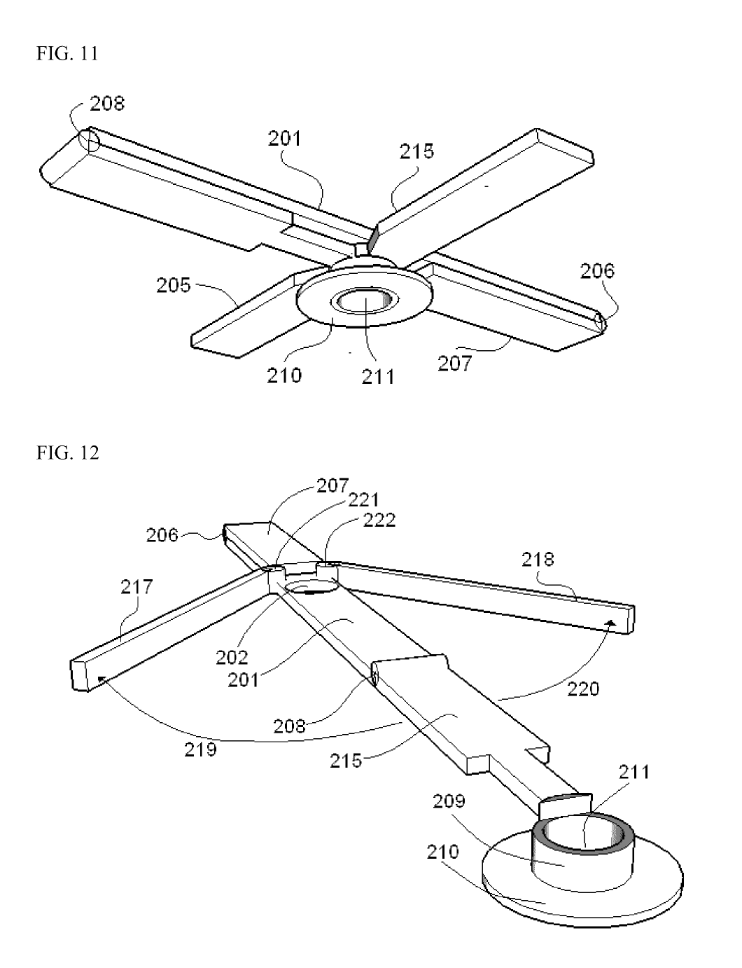

Referring to FIG. 11, the folding anchor of FIG. 7 is in its final folded position.

Referring to FIG. 12, the folding anchor of FIG. 7 is constructed somewhat differently. The sub-members 217 and 218 are branching out of the second member in the directions of arrow 219 and 220 respectively.

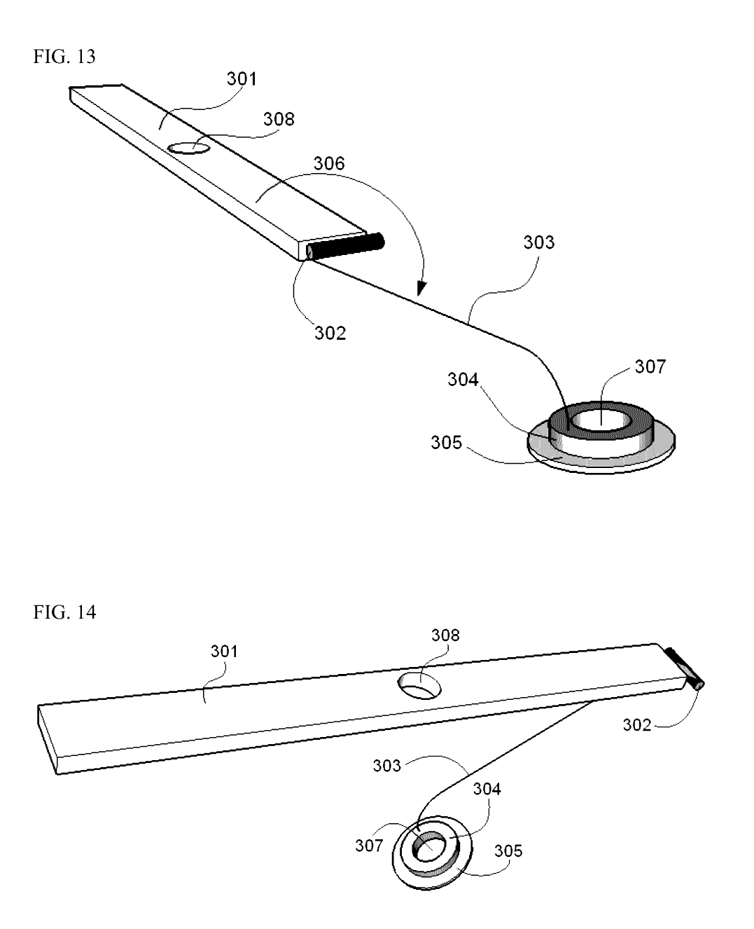

Referring to FIG. 13, the first member 301 of the folding anchor comprises a fastening receiver 308. The first member 301 is coupled to the second member 303 by a pivoting axis 302. The first member 301 is rotating side-to-side to the second member 303, which allows an overlap rotation. This allows the frontal surface of the first member 301 to reach the back surface of the panel (not shown). Means for mounting the last member into the insertion hole are represented by disc 305. A conduit 307 for the insertion of a fastening rod is shown.

Referring to FIG. 14, the folding anchor of FIG. 13, the first member 301 has passed the thickness of the panel and has reached the space behind the panel and it is being rotated by pivoting axis 302 in the direction of arrow 306.

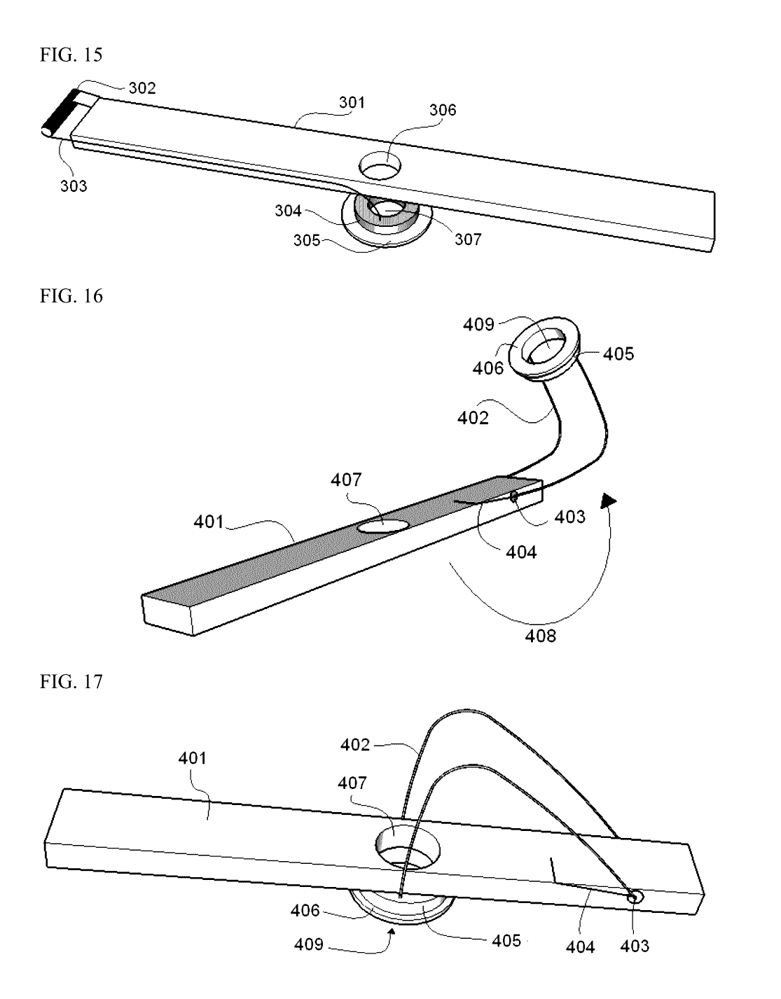

Referring to FIG. 15, the folding anchor of FIG. 13 is in its final folded position wherein the conduit 307 is aligned with the fastening receiver 306.

Referring to FIG. 16, the first member 401 of the folding anchor comprises a fastening receiver 407. The first member is coupled to the second member 402 by a pivoting axis 403. The second member 402 is made of two bended wires having some elastic properties. The first member 401 is rotating side-to-side to the second member 402. This allows the frontal surface of the first member 401 to reach the back surface of the panel (not shown). A spring 404 powers the rotation of the first member 401, however this rotation could be achieved by gravity alone. Means for mounting the last member into the insertion hole are represented by ring 405 and disc 406. A conduit 409 for the insertion of a fastening rod is shown.

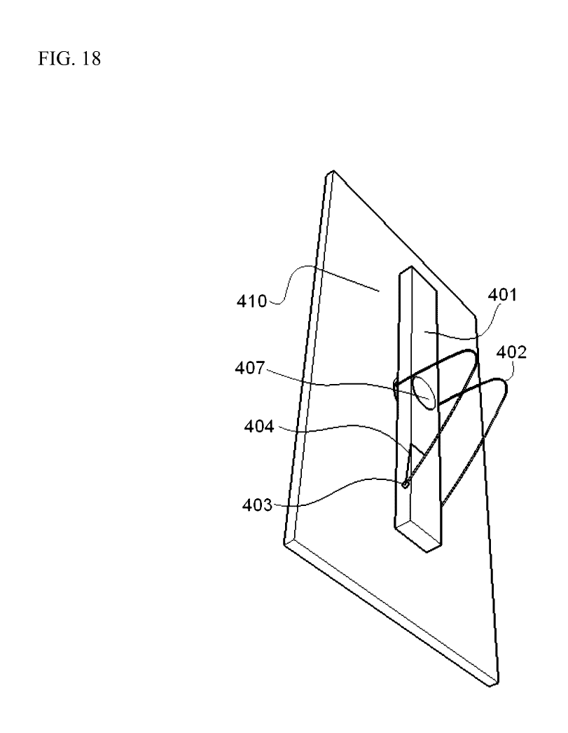

Referring to FIG. 17, the folding anchor of FIG. 16 is in its final folded position wherein the conduit 409 is aligned with the fastening receiver 407.

Referring to FIG. 18, the folding anchor of FIG. 16 is in its final folded position wherein the panel 410 is shown and the mounting means is mounted into the insertion hole. The frontal surface of the first member 401 lays on the back surface of the panel 410. The elastic properties of the second member 402 are used to press on the first member 401 against the back surface of the panel 410.

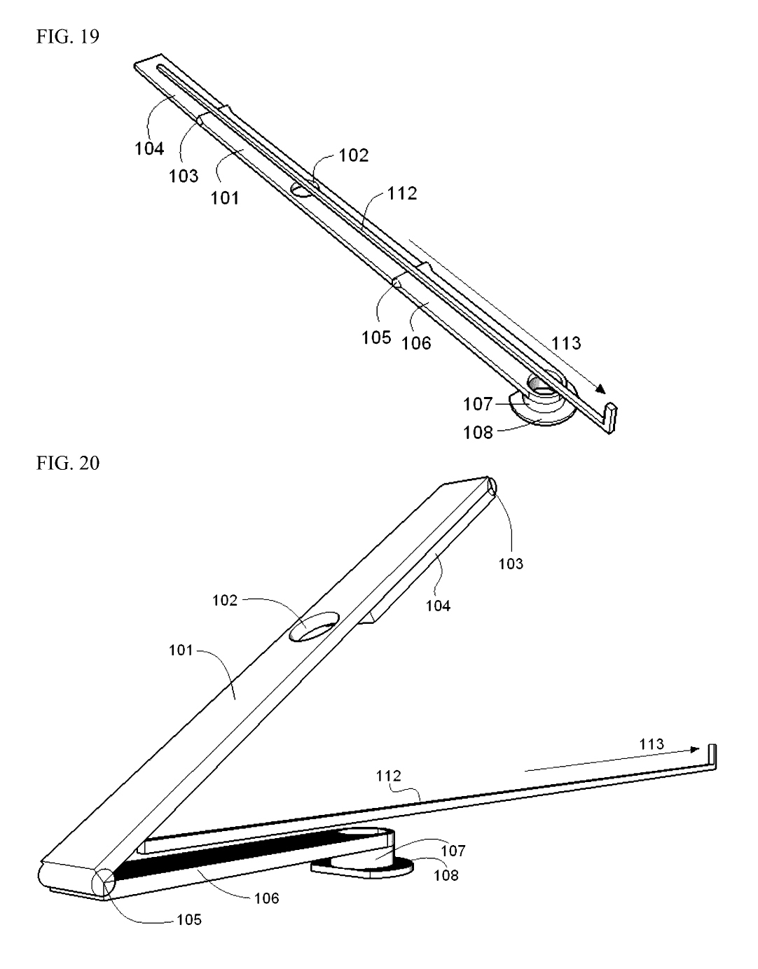

Referring to FIG. 19, the folding anchor of FIG. 1 having means for triggering release of members to fold. The members of the folding anchor are locked in an unfolded position and upon release of the triggering means, members of the folding anchor rotate to their final position. The triggering means in FIG. 19, is represented by a pull-rod 112 that is pulled back in the direction of arrow 113. As the first member 104 is released, it rotates toward the second member 101.

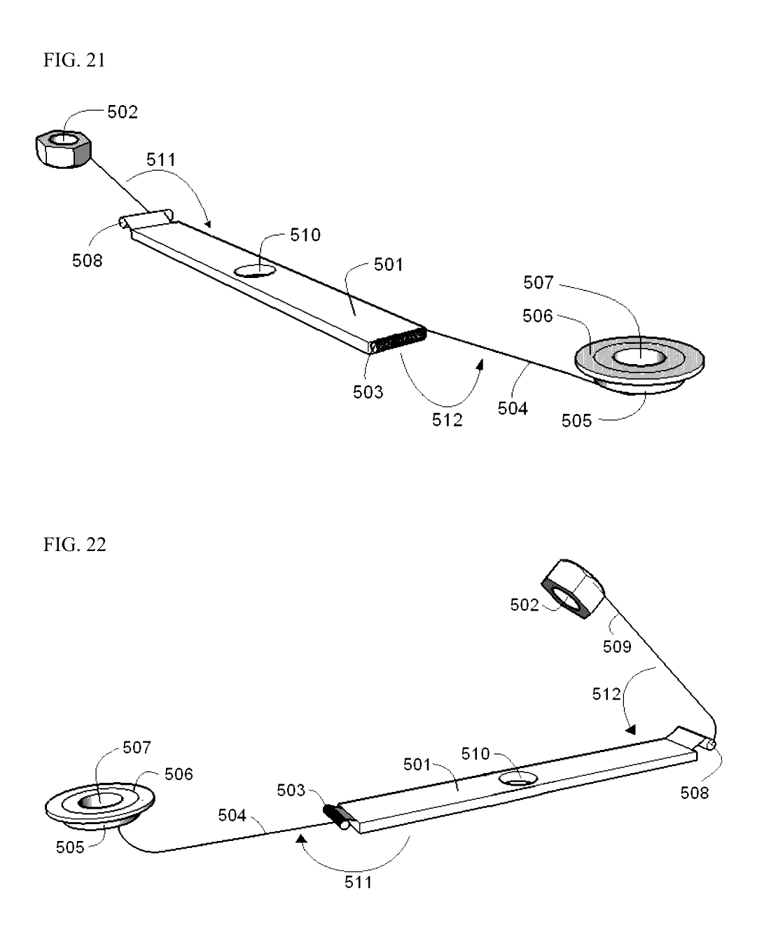

Referring to FIG. 20, the pull-rod 112 of the folding anchor of FIG. 19 is further pulled back in the direction of arrow 113. The first member 104 has completed its rotation toward the second member 101 and the second member 101 is rotating toward the third member 106. Referring to FIG. 21, the first member 509 of the folding anchor comprises a fastening receiver 502. Notice that the wire part of member 509 may not participate in transmittal of pulling forces from the fastening receiver 502 via member 501 to the back surface of the panel. The first member 509 is coupled to the second member 501 by a pivoting axis 508. The second member 501 is coupled to the third member 504 by a pivoting axis 503. The second member 501 is rotating side-to-side to the third member 504. This allows the frontal surface of the second member 501 to reach the back surface of the panel (not shown). Means for mounting the last member into the insertion hole are represented by ring 505 and disc 506 of the third member 504. A conduit 507 for the insertion of a fastening rod is shown. The fastening rod is inserted through the conduit 507 into means for passage 510 and is fastened into fastening receiver 502. Referring to FIG. 22, the folding anchor of FIG. 21, the first member 509 and its fastening receiver 502 have passed the thickness of the panel and have reached the space behind the panel. The first member 509 is being rotated by pivotal axis 508 in the direction of arrow 512. Means for passage 510 of a fastening rod to be inserted through the conduit 507 and be fastened into fastening receiver 502 is shown.

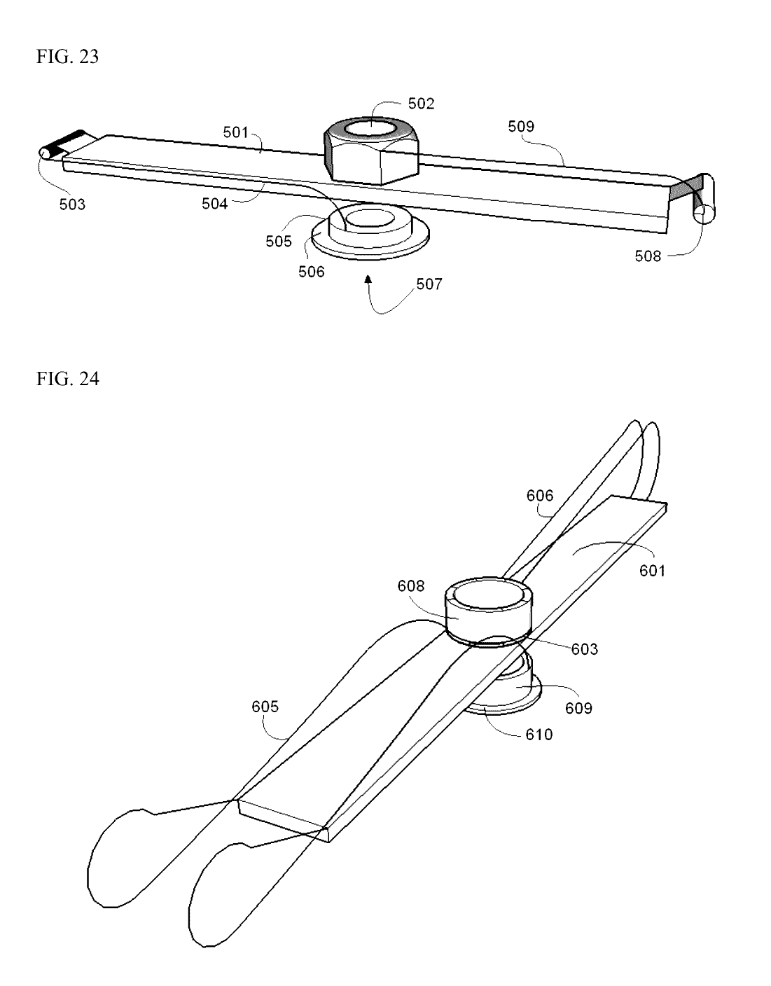

Referring to FIG. 23, the folding anchor of FIG. 21 is in its final folded position wherein the conduit 507 is aligned with means for passage 510 and the fastening receiver 502.

Referring to FIG. 24, the first member of the folding anchor is the fastening receiver 608. The first member 608 is coupled to the second member 601 by means for repositioning represented by elastic wires 606. The third member is the means for mounting represented by ring 609 and disc 610. The second member 601 is coupled to the third member 609 and 610 by means for repositioning represented by elastic wires 605. The second member 601 is moving side-to-side to the wires of means for repositioning 605.

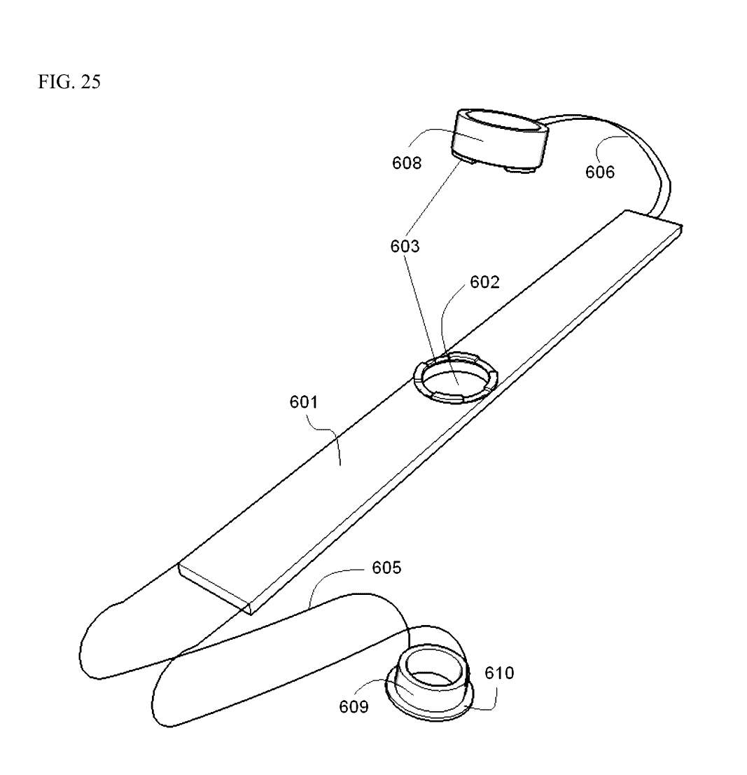

Referring to FIG. 25, the folding anchor insertion is done in its unfolded position. The first member, fastening receiver 608 is inserted first and then means for repositioning 606, then the second member 601 and then means for repositioning 605 in a zigzag fashion. Lastly, the third member ring 609 and disk 610 are mounted into the insertion hole. Another feature shown here is means for preventing of rotation 603 by the threading of the fastening rod. Similar means for preventing rotation can be placed between the fastening receiver and members of the stack, between each two members of the stack and between members and the back surface of the panel.

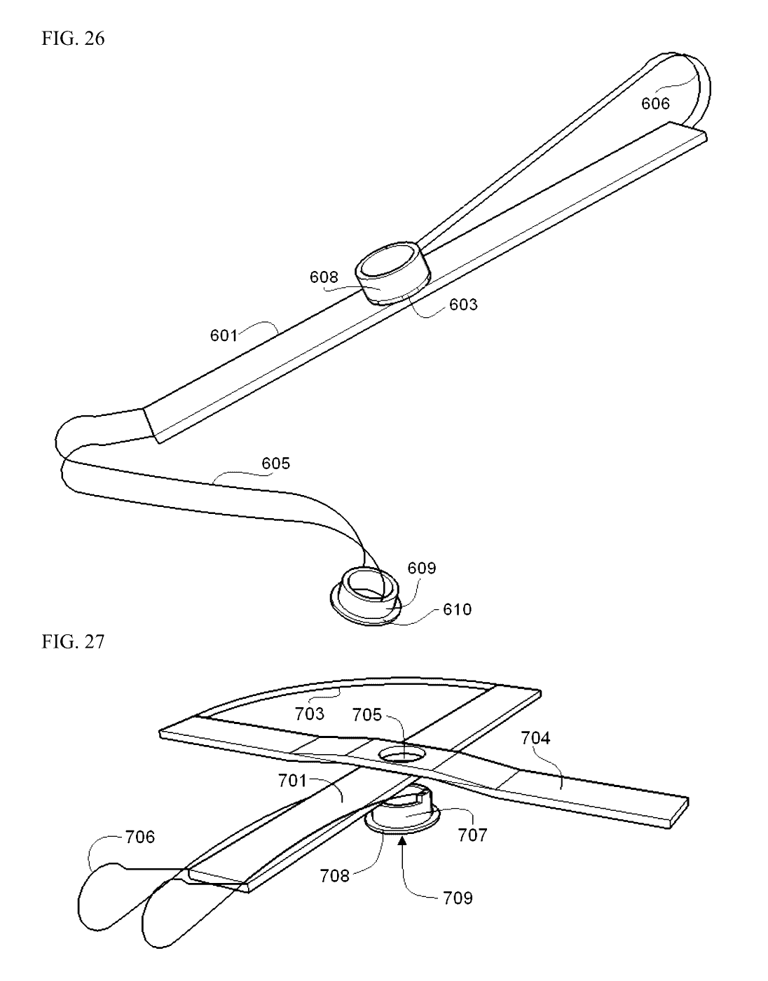

Referring to FIG. 26, the folding anchor of FIG. 24, the first member 608, means for repositioning 606 and at least half of member 601 have passed the thickness of the panel and have reached the space behind the panel. The first member 608 repositioned back to its folded position.

Referring to FIG. 27, the first member 704 of the folding anchor comprises a fastening receiver 705. The first member 704 is coupled to the second member 701 by means for repositioning, elastic connectors 703. The third member is the means for mounting represented by ring 707 and disc 708. The second member 701 is coupled to the third member, ring 707 and disc 708, by elastic connectors 706. The second member 601 is moving side-to-side to elastic connectors 706.

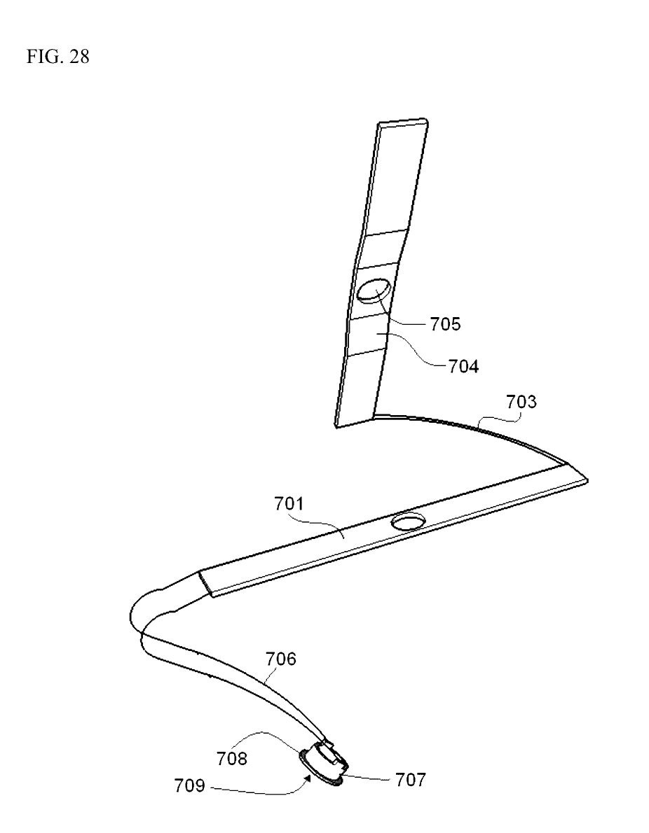

Referring to FIG. 28, the folding anchor insertion is done in its unfolded position. The first member, the fastening receiver 704, is inserted first, and then means for repositioning 703, then the second member 601and then means for repositioning 706 in a zigzag fashion. Lastly, the last member ring 707 and disc 708 are mounted into the insertion hole.

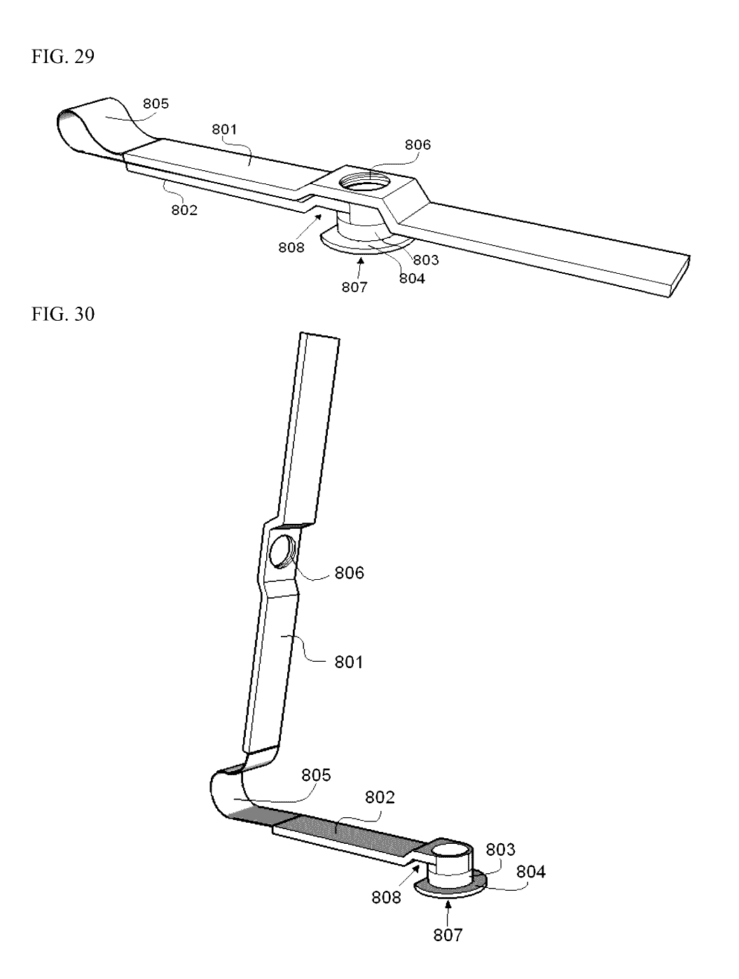

Referring to FIG. 29, the first member 801 of the folding anchor comprises a fastening receiver 806. The first member 801 is coupled to the second member 802 by means for repositioning in the form of elastic connectors 805. The second member comprises means for mounting represented by ring 803 and disc 804. Means for preventing non-flushed seating of the stack on the back surface of the panel is represented by space 808 created around the mounting ring 803. This space may contain excess panel material that was pushed backwards by hasty and forceful drilling of the insertion hole.

Referring to FIG. 30, the folding anchor insertion is done in its unfolded position. The first member 801 and its fastening receiver 806, is inserted first, and then means for repositioning 805, then the second member 802 in a zigzag fashion. Lastly, ring 803 and disc 804 are mounted into the insertion hole.

1. A folding anchor inserted through an insertion hole of a panel comprising:
a. at least two members ordered consecutively from the first member to the last member of said folding anchor,
b. each two consecutive members of said members are coupled by means for repositioning the leading member of said two consecutive members relatively to the trailing member of said two consecutive members,
c. one member of said members that is not said last member comprises a fastening receiver,
d. said last member comprises means for mounting said last member into said insertion hole and yet maintaining a conduit in said insertion hole for later insertion of a fastening rod through said conduit to be fastened into said fastening receiver,
e. said members are consecutively inserted through said insertion hole and reach the back side of said panel where each of said leading members is predeterminedly repositioned relatively to its said trailing member, and said last member is mounted into said insertion hole by said means for mounting so that said members final position relatively to said insertion hole is also predetermined,
f. a stack of contiguous members made of at lease one member of said members is formed on a portion of the back surface of said panel and the member at the apex of said stack positioned farther back is said member comprises said fastening receiver,
g. said fastening receiver is aligned with said conduit, and
h. said stack comprises means for passage of said fastening rod from said conduit to said fastening receiver,
whereby said members of said folding anchor are consecutively inserted in their unfolded form into said insertion hole wherein said leading members of said anchor are pushed into said insertion hole by their said trailing members and said leading members that have passed the thickness of said panel predeterminedly reposition relatively to their said trailing members and lastly said last member is mounted into said insertion hole of said panel by said means for mounting so that said fastening rod is inserted through said conduit and said fastening rod is fastened into said fastening receiver and forces applied by said fastening rod on said fastening receiver are transmitted and distributed from said fastening receiver through said stack to said portion of said back surface of said panel and thereby said forces are counteracted by counter forces generated by said panel.

2. The folding anchor of claim 1, wherein the trailing portion of said leading member of said two consecutive members overlaps the leading portion of said trailing member of said two consecutive members, whereby insertion of said trailing member through said insertion hole begins before the insertion of said leading member is completed.

3. The folding anchor of claim 1, wherein said one member comprises said fastening receiver is the only member of said stack.

4. The folding anchor of claim 1, wherein at least one member of said members further comprises at least one sub-member and at least one means for repositioning, wherein said sub-member is predeterminedly repositioned by said means for repositioning whereby said sub-member is part of said stack that transmits and distributes said forces applied by said fastening rod on said fastening receiver via said stack to said portion of said back surface of said panel.

5. The folding anchor of claim 1, wherein said one member comprises said fastening receiver further comprises at least one sub-member and at least one means for repositioning, wherein said fastening receiver is an exclusive part of said sub-member and said sub-member is predeterminedly repositioned by said means for repositioning, whereby a desired repositioning of said fastening receiver relatively to said one member comprises said fastening receiver is accomplished.

6. The folding anchor of claim 1, further comprising at least one means for preventing rotation of said members of said folding anchor by shear forces created by threading of said fastening rod.

7. The folding anchor of claim 1, further comprising at least one means for triggering release of said members to reposition, whereby an operator decides on the exact timing of releasing said members to reposition.

8. The folding anchor of claim 1, wherein said means for repositioning further comprising at least one elastic connector.

9. The folding anchor of claim 1, wherein at least one member of said members has some elastic properties, whereby better positioning of other members of said members is accomplished.

10. A method for installing a folding anchor into a panel, comprising:
a. creating an insertion hole in said panel in a predetermined size and location for the insertion of said folding anchor,
b. inserting members of said folding anchor consecutively in their unfolded form from the first member of said folding anchor to the last member of said folding anchor,
c. each preceding member of said members is pushed into said insertion hole by its subsequent member of said members,
d. one of said preceding members inserted into said insertion hole comprises a fastening receiver,
e. said preceding members that have passed the thickness of said panel and have reached the space behind said panel predeterminedly reposition relatively to their said subsequent members,
f. said last member is mounted into said insertion hole, and
g. a fastening rod is inserted through said insertion hole and is fastened into said fastening receiver and said fastening rod transmits pulling forces to said fastening receiver and said fastening receiver transmits said pulling forces to a stuck of at least one member of said members of said folding anchor and said stack further transmits said pulling forces to a portion of said back surface of said panel,
whereby said pulling forces are counteracted by counter forces generated by said panel.

11. The folding anchor of claim 12, wherein insertion of said subsequent member through said insertion hole begins before the insertion of said preceding member is completed.

12. The method of claim 12, wherein said step of predeterminedly reposition said preceding members relatively to their said subsequent members further comprises a step of activating means for triggering release of said preceding members to reposition relatively to their said subsequent members, whereby an operator decides on the exact timing of releasing said members to reposition.

13. A folding anchor comprising:
a. at least two consecutive members,
b. each two consecutive members of said consecutive members are coupled by means for repositioning the leading member of said two consecutive members relatively to the trailing member of said two consecutive members,
c. one member of said consecutive members that is not said last member of said consecutive members comprises a fastening receiver,
d. the last member of said consecutive members comprises means for mounting said last member into an insertion hole made in a panel in a predetermined size and location,
e. said means for mounting maintains a conduit through said insertion hole for later insertion of a fastening rod to be fastened into said fastening receiver,
f. said consecutive members and their means for repositioning are inserted consecutively through said insertion hole into the space behind said panel,
g. each member of said consecutive members except for said last member that has passed the thickness of said panel and has reached said space behind said panel is predeterminedly repositioned relatively to its said trailing member,
h. said last member is mounted into said insertion hole by said means for mounting and said last member hold all other members of said consecutive members in a predetermined final position relatively to said insertion hole so that said fastening receiver is aligned with said conduit
i. members of said consecutive members that are positioned between said conduit and said fastening receiver comprising means for passage of said fastening rod from said conduit to said fastening receiver, and
j. at lease one member of said consecutive members combines to a stack of contiguous members starting in the back with said member having said fastening receiver and ending in the front on a portion of the back surface of said panel,
whereby said consecutive members of said folding anchor are consecutively inserted in their unfolded form into said insertion hole wherein members that have passed the thickness of said panel predeterminedly reposition and lastly said last member is mounted into said insertion hole of said panel by said means for mounting so that said fastening rod can be inserted through said conduit and said fastening rod can be fastened into said fastening receiver and forces applied by said fastening rod on said fastening receiver are transmitted and distributed from said fastening receiver through said stack to said portion of said back surface of said panel and thereby said forces are counteracted by counter forces generated by said panel.

14. The folding anchor of claim 13, wherein the trailing portion of said leading member of said two consecutive members overlaps the leading portion of said trailing member of said two consecutive members, whereby insertion of said trailing member through said insertion hole begins before the insertion of said leading member is completed

15. The folding anchor of claim 13, wherein said one member comprises said fastening receiver is the only member of said stack.

16. The folding anchor of claim 13, wherein at least one member of said consecutive members further comprises at least one sub-member and at least one means for repositioning, wherein said sub-member is predeterminedly repositioned by said means for repositioning whereby said sub-member is part of said stack that transmits and distributes said forces applied by said fastening rod on said fastening receiver via said stack to said portion of said back surface of said panel.

17. The folding anchor of claim 13, wherein said one member comprises said fastening receiver further comprises at least one sub-member and at least one means for repositioning, wherein said fastening receiver is an exclusive part of said sub-member and said sub-member is predeterminedly repositioned by said means for repositioning, whereby a desired repositioning of said fastening receiver relatively to said one member comprises said fastening receiver is accomplished.

18. The folding anchor of claim 13, further comprising at least one means for preventing rotation of said consecutive members of said folding anchor by shear forces transmitted by threading of said fastening rod.

19. The folding anchor of claim 13, further comprising at least one means for triggering release of said consecutive members to reposition, whereby an operator decides on the exact timing of releasing said members to rotate.

20. The folding anchor of claim 13, wherein at least one member of said consecutive members has some elastic properties, whereby better positioning of other members of said members is accomplished.
